(19) United States
(12) Patent Application Publication
(10) Pub. No.: US 2021/0371727 A1
(43) Pub. Date: Dec. 2, 2021

(54) USE OF POLYALKOXYLATED ALCOHOLS IN POST-CHOPS OILFIELD RECOVERY OPERATIONS

(71) Applicant: Dow Global Technologies LLC, Midland, MI (US)

(72) Inventors: Biplab Mukherjee, Pearland, TX (US); Abu Mokhtarul Hassan, Pearland, TX (US); Harpreet Singh, Pearland, TX (US)

(21) Appl. No.: 16/319,069

(22) PCT Filed: Jul. 19, 2017
(86) PCT No.: PCT/US2017/042712

§ 371 Date: Jan. 18, 2019

Related U.S. Application Data
(60) Provisional application No. 62/377,091, filed on Aug. 19, 2016.

(51) Int. Cl. C09K 8/588; E21B 43/16

(52) U.S. Cl. CPC C09K 8/588; E21B 43/16

(57) ABSTRACT

The present invention relates to a method to stimulate additional oil recovery from a post-CHOPS well in an oil-bearing formation. Specifically, the present invention involves the step of treating a post-CHOPS well in an oil-bearing formation with a composition comprising an aqueous solution of a polyoxylated alcohol.

### FIELD OF THE INVENTION

The present invention relates to the recovery of oil from a post-CHOPS well in an oil-bearing formation. More particularly, the present invention is an improved method for recovery of oil from a post-CHOPS well in an oil-bearing formation using an aqueous solution of one or more polyoxylated alcohol.

### BACKGROUND OF THE INVENTION

Oil can generally be separated into classes or grades according to its viscosity and density. Grades of oil that have a high viscosity and density may be more difficult to produce from a reservoir to the surface. In particular, extra heavy oil requires enhanced oil recovery techniques for production. In the following description, the generic term “oil” includes hydrocarbons, such as extra heavy oil, as well as less viscous grades of oil.

A large portion of the world's potential oil reserves is in the form of heavy or extra heavy oil, such as the Orinoco Belt in Venezuela, the oil sands in Canada, and the Ugnu Reservoir in Northern Alaska. Currently, some existing oil reservoirs are exploited using thermal enhanced oil recovery techniques that usually result in recovery efficiencies within a range of about 20% to 75%. One of the most common thermally enhanced oil recovery techniques is steam injection by which heat enthalpy from the steam is transferred to the oil by condensation. The heating reduces the viscosity of the oil to allow drainage and collection. Thus, oil recovery is high if the temperature can be maintained near the temperature of the injected steam.

In deep reservoirs or thin reservoirs, much heat is lost through the wellbore to the rock surrounding the reservoir. Then traditional steam injection is little more than a hot water flood and loses much of its effectiveness in reducing the oil's viscosity and improving oil production.

A current practice is to use Cold Heavy Oil Production with Sand (“CHOPS”). As the name implies, this utilizes primary production without heat. In general, a well is drilled into an unconsolidated reservoir, such as a highly porous tar sand formation. The well is perforated and a pumping device may be lowered into the well. The combination of reservoir pressure and artificial lift provided by the pumping device drives the oil in the reservoir to the well surface. Sand influx with the oil is encouraged by increasing the “draw down” pressure in the well (i.e., the differential pressure that drives fluids from the reservoir into the well), which enlarges the access of oil flow and decreases the resistance of fluid flow. A mixture of heavy oil and sand is produced and separated at the surface. Sand generation during CHOPS results in creation of highly permeable zones in areas surrounding the producer well, which allows greater fluid flux to the wellbore. With more sand production, the permeable zones extend deep inside reservoirs in the form of highly branched and permeable channels known as “wormholes”. Interconnection of several wormholes inside the reservoir can give rise to highly networked porous channels with permeability around 10,000 mDarcy. One shortcoming of CHOPS is that the recovery efficiency can be as low as 5% of the original oil in place. Another shortcoming is that after the economic production limit is reached using the CHOPS process, the reservoir may not be suitable for other enhanced oil recovery techniques.

As the number of potential heavy oil reservoirs increases and the complexity of the operating conditions of these reservoirs increases, there is a continuous need for efficient enhanced oil recovery techniques and methods.

### SUMMARY OF THE INVENTION

The present invention is a method to stimulate additional oil recovery from a post-CHOPS well in an oil-bearing formation wherein said post-CHOPS well has one or more injector, one or more producer, and one or more wormhole, said method comprising the step of providing to the oil-bearing formation an aqueous solution comprising, consisting essentially of, or consisting of one or more polyoxylated primary alcohol having the structure:

RO—(CH₂CH(CH₃)O)ₘ(C₂H₄O)ₙH I

or

RO—(C₂H₄O)ₙ(CH₂CH(CH₃)O)ₘH II
wherein R is a linear, branched, cyclic alkyl, phenyl, or alkyl phenyl group of equal to or greater than 4 carbons, preferably n-butyl, n-pentyl , 2-methyl-1-pentyl, n-hexyl, n-heptyl, n-octyl, 2-ethylhexyl, 2-propylheptyl, phenyl, cyclohexyl, or nonylphenol,
m is 0 to 12, preferably 5 to 12, more preferably 8 or 12, and
n is 7 to 20, preferably 10 or 15, preferably the solution is from 0.1 to 10 weight percent polyoxylated alcohol.

Preferably, the method disclosed herein above comprises, consists essentially of, or consists of the steps of: (a) injecting the aqueous solution of the polyalkoxylated alcohol into one or more injector to introduce the aqueous solution of the polyalkoxylated alcohol into one or more one wormhole and (b) recovering released oil from one or more producer.

Preferably, the method disclosed herein above further comprises, consists essentially of, or consists of between step (a) and step (b) the steps of: (c) pressurizing the formation with gas, (d) pushing the polyalkoxylated alcohol solution deep inside the formation, (e) soaking of the formation with polyalkoxylated alcohol solution, and (f) reducing the formation pressure.

### BRIEF DESCRIPTION OF THE DRAWINGS

FIG. 1 is a photograph of oil transfer into water at various NaCl concentrations for Examples of the invention versus Comparative Examples not of the present invention.

FIG. 2 is a diagram of how water imbibition is determined using Amott cells.

### DETAILED DESCRIPTION OF THE EMBODIMENTS

Oil fields containing relatively thin layers of heavy oil in unconsolidated sandstone formations have been produced under primary production via a method that is commonly referred to as Cold Heavy Oil Production with Sand (CHOPS). The thin hydrocarbon-containing layers render steam flooding a non-viable option due to high heat losses to non-productive confining layers above and below. The crude oil is most effectively produced with progressive cavity pumps by allowing the sand to be produced concurrently with the oil and gas. Through a solution gas drive/pressure depletion mechanism, in some cases with contributing aquifer pressure support, a combination of foamy oil, gas, water, and sand are produced until the oil production tails off over time and water production increases to the point where it becomes uneconomical to continue production. At this point, the wells are generally suspended after only producing from 5% to 15% of the oil that was originally in place with an average of around 5% recovery. It is estimated there may be as many as 30,000 of these suspended CHOPS wells in Canada alone.

The invention relates to a method of stimulating additional oil recovery from a post-cold heavy oil production with sand (post-CHOPS) well in an oil-bearing formation. The method comprises the steps of injecting an aqueous solution of a polyalkoxylated alcohol into the post-CHOPS oil-bearing formation via a well bore to introduce the aqueous solution of the polyalkoxylated alcohol into at least one wormhole within the post-CHOPS oil-bearing formation and recovering oil from the post-CHOPS oil-bearing formation.

CHOPS oil production results in the formation of wormholes in the unconsolidated sand matrix. These relatively-open, highly-porous channels, or conduits, where the sand has been removed-in addition to the halo of disturbed sand surrounding them are beneficial during (primary) CHOPS production to facilitate the flow of the oil, water, gas, and sand mixture. These wormholes can be as large as 10 cm and can extend hundreds of meters into the formation. These wormholes, however, are often detrimental to subsequent secondary or tertiary recovery techniques, since they bypass large portions of the reservoir and lead to early water breakthrough, thereby severely degrading intended flooding sequences to improve sweep and promote contact with the more virgin areas of the formation. In the methods of the invention, these same wormholes can provide a high permeability pathway deep into the formation for introduction of the polyalkoxylated alcohol.

Preferred polyalkoxylated primary alcohols are represented by the following formula:

RO—(CH₂CH(CH₃)O)ₘ(C₂H₄O)ₙH I

or

RO—(C₂H₄O)ₙCH₂CH(CH₃)O)ₘH II
wherein R is a linear, branched, cyclic alkyl, phenyl, or alkyl phenyl group of equal to or greater than 4 carbons and preferably equal to or less than 36 carbons, preferably n-butyl, n-pentyl , 2-methyl-1-pentyl, n-hexyl, n-heptyl, n-octyl, 2-ethylhexyl, 2-propylheptyl, phenyl, cyclohexyl, or nonylphenol,
m is 0 to 12, preferably 5 or 12, more preferably 8 to 12, and
n is 7 to 20, preferably 10 or 15.

The polyalkoxylated alcohol is present in the aqueous solution of the present invention in an amount equal to or greater than 0.01 weight percent, preferably equal to or greater than 0.1 weight percent, preferably equal to or greater than 0.5, preferably equal to or greater than 1 weight percent weight percent based on the weight of the aqueous solution.

The polyalkoxylated alcohol is present in the aqueous solution of the present invention in an amount equal to or less than 25 weight percent, preferably equal to or less than 15 weight percent, preferably equal to or less than 10 weight percent, preferably equal to or less than 5 weight percent based on the weight of the aqueous solution.

In one embodiment of the method of the present invention, the polyalkoxylated alcohol is injected with produced water (or a suitable carrier) either alone or in combination with a base to make the formulation alkaline in nature (preferably pH equal to or greater than 10.0).

In one embodiment of the method of the present invention, the polyalkoxylated alcohol is non-ionic in nature but can be applied in combination with ionic chemistry, such as an ionic surfactant, to increase compatibility with the carrier or formation fluid

The present invention is a method to stimulate additional oil recovery from a post-CHOPS well in an oil-bearing formation wherein said well has one or more injector, one or more producer, and one or more one wormhole, said method comprising the step of providing to the oil-bearing formation an aqueous solution of one or more polyoxylated alcohol.

In one embodiment, the method of the present invention is a flow through system comprising the steps of (a) injecting the aqueous polyoxylated alcohol solution (using produced water or any suitable water) into one or more well bore to introduce the aqueous solution of the polyalkoxylated alcohol into at one or more one wormhole of the post-CHOPS well in an oil-bearing formation and (b) then recovering released oil from one or more producer.

In one embodiment, the method of the present invention comprises injecting an aqueous solution of the polyalkoxylated alcohol and recovering oil by utilizing Huff-and-Puff techniques, herein after referred to as WAHP (Water-Additive Huff and Puff). The WAHP method comprises the steps of: (a) injecting the aqueous solution of the polyalkoxylated alcohol into one or more injector to introduce the aqueous solution of the polyalkoxylated alcohol into one or more one wormhole, (b) pressurizing the formation with any suitable gas, such as carbon dioxide (CO₂), nitrogen (N₂), methane (CH₃), flue gas and the like or mixtures of hydrocarbons such as methane with any of ethane, propane, or butane, compressed natural gases, flue gas and the like (c) pushing the polyalkoxylated alcohol solution deep inside the formation, (d) soaking of the formation with polyalkoxylated alcohol solution, (e) reducing the formation pressure, and (f) recovering released oil from one or more producer.

The ambient temperature operation of the method of the present invention eliminates the need for heat. Another advantage is that produced water is inexpensive and is available in sufficient quantity in any oil fields.

### EXAMPLES

A shake test involving mixing three parts water and one part heavy oil is conducted at 80° C. The water is prepared by adding NaCl in DI water at different concentrations of 0.25 wt % to 5.0 wt%. Experiments are conducted both at near neutral pH and ≥10.0 (pH is adjusted using Na₂CO₃) and also with field water. The oil used is dead oil obtained from the field and has a viscosity of greater than 40,000 cP at room temperature.

The following additives are tested and are compared to the baseline (without an additive):

“Additive-1” is a polyalkoxylated alcohol of formula I where R is 2 ethylhexoxy, m is 5, and n is 14;

“Additive-2” is nonylphenol polyethylene glycol ether of formula 1 where R is nonylphenol, m is 0, and n is 13;

“Additive-3” is a polyalkoxylated alcohol of formula I where R is 2 ethoxy, m is 8, and n is 12;

“Additive-4” is a polyalkoxylated alcohol of formula R is 2 ethylhexoxy, m is 5, and n is 6;

“Additive-5” is alkyl polyglucoside;

and

“Additive-6” is polyalkoxylated secondary alcohol of formula 1 where R is a branched C12 alkyl group, m is 0, and n 10.

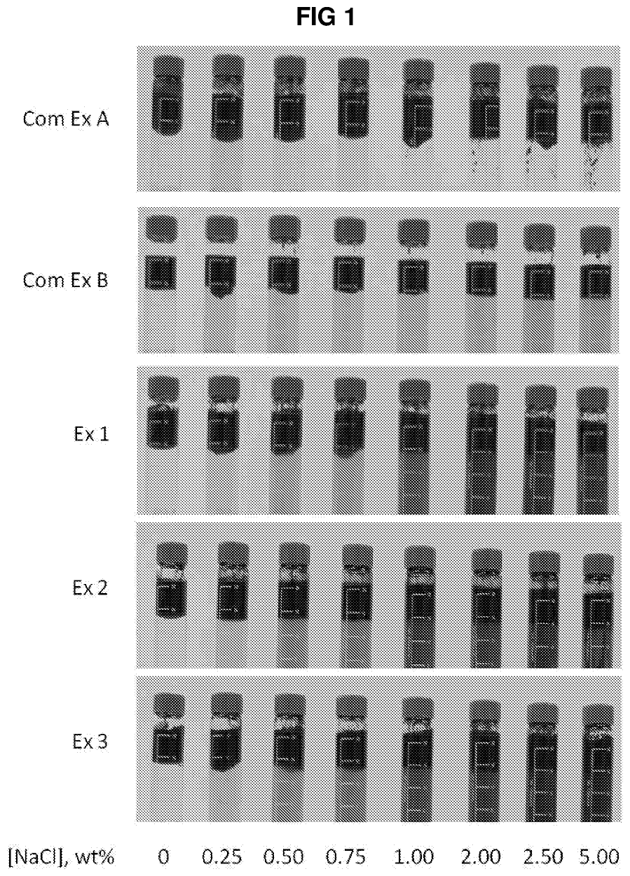

For the test, 3 parts of synthetic water followed by 1 part of heavy oil is transferred into a 25 ml glass vial. For treatments with additive, the additive is added to water before hand to get a final concentration of 1000 ppm. The vial is then heated overnight at 80° C. in an oven and is the shaken at 80 rpm for 2 hours at 80° C. and is transferred back inside the oven and is allowed to settle overnight at 80° C. Comparative Example A has no additive, Example 1 uses Additive-1, Example 2 used Additive-2, Example 3 used Additive-3, and Comparative Example B uses Additive-6. Photographs of the samples after overnight settling are shown in FIG. 1.

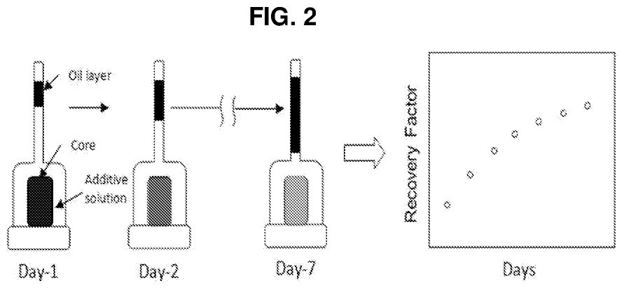

Water-imbibition experiments are performed using Amott Cells (FIG. 2). Water-wet heavy oil saturated unconsolidated sand cores are prepared. The porosities of the cores are 34 to 37%, water saturation 8 to 12%, and oil saturation 90 to 86%. Similar ranges of porosities and saturation are reported in literature for post CHOPS wells. Cores are prepared with 200 sieve size mesh baskets. Water imbibition experiments are conducted in standard Amott cells at room temperature using the prepared cores. The cores are placed at the bottom of Amott cells. A baseline (with no additive) and 1000 ppm concentrations of each additive are slowly added in separate cells and are filled up to the top. Water imbibed in core and released oil, which is collected in the top vertical cylindrical graduated section of the Amott cell. Comparative Example A has no additive, Example 1 uses Additive-1, Comparative Example B uses Additive-6, Comparative Example C uses Additive-4, and Comparative Example D uses Additive-5. The oil release rates for Comparative Examples A to D and Example 1 are listed in Table 1, values in percents.

TABLE 1

| Day | Com Ex A | Ex 1 | Com Ex B | Com Ex C | Com Ex D |
|---|---|---|---|---|---|
| 1 | 4.6 | 20.2 | 10.7 | 5.9 | 2.5 |
| 2 | 9.5 | 33.3 | 16.6 | 11.5 | 7.1 |
| 3 | | 38.4 | | | |
| 4 | | 40.2 | | | |
| 5 | 14.3 | | 20.2 | 18.2 | 10.5 |
| 6 | 17.7 | | 24.3 | 20.3 | 17.4 |
| 7 | 16.5 | 43.9 | 25.4 | 18.7 | 17.9 |

What is claimed is:

1. A method to stimulate additional oil recovery from a post-CHOPS well in an oil-bearing formation comprising the step of providing to the oil-bearing formation an aqueous solution comprising one or more polyoxylated primary alcohol having the structure:
RO—(CH₂CH(CH₃)O)ₘ(C₂H₄O)ₙH I
or
RO—(C₂H₄O)ₙ(CH₂CH(CH₃)O)ₘH II
wherein R is a linear, branched, cyclic alkyl, phenyl, or alkyl phenyl group of equal to or greater than 4 carbons,
m is 0 to 12, and
n is 7 to 20,
wherein said post-CHOPS well has one or more injector, one or more producer, and one or more one wormhole.

2. The method of claim 1 comprising the step of:
(a) injecting the aqueous solution of the polyalkoxylated alcohol into one or more injector to introduce the aqueous solution of the polyalkoxylated alcohol into one or more one wormhole and
(b) recovering released oil from one or more producer.

3. The method of claim 2 further comprising between step (a) and step (b) the steps:
(c) pressurizing the formation with gas,
(d) pushing the polyalkoxylated alcohol solution deep inside the formation,
(e) soaking of the formation with polyalkoxylated alcohol solution, and
(f) reducing the formation pressure.

5. The method of claim 1 wherein the aqueous solution comprises from 0.1 weight percent to 10 weight percent polyoxylated alcohol.

6. The method of claim 1 wherein R is n-butyl, n-pentyl, 2-methyl-1-pentyl, n-hexyl, n-heptyl, n-octyl, 2-ethylhexyl, 2-propylheptyl, phenyl, cyclohexyl, or nonylphenol.

7. The method of claim 1 wherein the aqueous solution further comprises a base to make the pH of the solution equal to or greater than 10.

8. The method of claim 1 wherein the aqueous solution further comprises an ionic surfactant.
